(19) United States
(12) Patent Application Publication
(10) Pub. No.: US 2025/0111282 A1
(43) Pub. Date: Apr. 3, 2025

(54) ALARM MONITORING AND EVALUATION SYSTEMS AND METHODS

(71) Applicant: CBRE, INC., DALLAS, TX (US)

(72) Inventors: Anno SCHOLTEN, Grapevine, TX (US); Brett Nesbitt, Dallas, TX (US); Victor Kaitell, Lawrenceville, GA (US); Joseph Grey, Franklin, NM (US); Maxx Scholten, Sante Fe, NM (US); Steve Evans, Los Angeles, CA (US); Kapil Ram Lahoti, Irving, TX (US)

(73) Assignee: CBRE, INC., DALLAS, TX (US)

(21) Appl. No.: 18/899,844

(22) Filed: Sep. 27, 2024

Related U.S. Application Data
(60) Provisional application No. 63/541,158, filed on Sep. 28, 2023.

(51) Int. Cl. G06N 20/00; G06F 9/451; G06F 18/23

(52) U.S. Cl. CPC G06N 20/00; G06F 9/451; G06F 18/23

(57) ABSTRACT

At least one processor may receive vent data describing a plurality of events related to equipment managed by a building management system. The at least one processor may process the event data using at least one machine learning model. Outputs of the at least one machine learning model may include at least a priority label and a probability score for each respective event in the event data. The at least one processor may generate a user interface within the building management system. The user interface may indicate at least the priority label and the probability score for at least one of the events.

### CROSS-REFERENCE TO RELATED APPLICATION

This application claims priority from U.S. Provisional Application No. 63/541,158, entitled “Alarm Monitoring and Evaluation Systems and Methods,” filed Sep. 28, 2013, the entirety of which is incorporated by reference herein.

### BACKGROUND

In the context of site management, alarms or issues are system notifications of an abnormal event or anomaly. The notifications are automated and can be routed to multiple locations and/or interfaces. Alarms are often, but not exclusively, environment related (e.g., high temperature alarm), asset related (e.g. fan and/or pump fail or filter dirty), power/electrical related, lift or elevator related, security/access related, equipment related (e.g., chillers or boilers), internet of things (IoT) related, etc. Alarms can be completely independent of one another and/or can be replicated or duplicate alarm(s) indicating a same or similar issue on a building management system (BMS) (as BMS alarms can routed remotely or can be sent to “manned” stations). Redundancies may further arise when one BMS is used with other systems and/or BMSs and/or is supplemented with IoT sensors.

Many sites being monitored have BMS and/or other systems that generate numerous alarms that can be categorized into three broad groups. Some alarms are genuine and real asset alarms needing investigation, follow up, or remedial actions. Some alarms are avoidable “real” alarms with minor re-engineering or parameter changes. Finally, some alarms are false, repeat, transient, or nuisance alarms that are just “noise.” Nuisance alarms can arise for a variety of reasons including, but not limited to, poor specifications, engineering, commissioning, and subsequent maintenance; tight, narrow, or inappropriate alarm threshold settings; inappropriate importance or priority rating; inappropriate maintenance of a status quo over time; inappropriate or unset “operational” (SOO) and/or “transient” inhibit periods; etc.

Ultimately nuisance alarms lead to what the industry labels as “alarm fatigue.” For example, if “good” sites have alarm counts typically in the range of 5-15 per day, some sites have alarm counts that exceed hundreds or even thousands of alarms per day. Much time and effort is expended on nuisance alarms, for example by checking false positives and/or unnecessary “truck rolls” to visit sites, with attendant costs and disruptions.

In view of this, there remains a high probability that real or critical alarms can be missed due to the “noise.” Generally, a skilled and time-consuming process sorting “fact from fiction” is required every time there is an alarm if the truth is to be discovered. More likely, due to the volume of alarms, many if not most BMS alarms are largely ignored or not taken seriously. Moreover, after the fact, the common practice for alarm annunciation is to mass acknowledge, with no individual alarm investigation or follow up.

### BRIEF DESCRIPTIONS OF THE DRAWINGS

FIG. 1 shows an example alarm monitoring and evaluation system according to some embodiments of the disclosure.

FIG. 2 shows an example alarm monitoring and evaluation process according to some embodiments of the disclosure.

FIG. 3 shows an example event detection and interpretation process according to some embodiments of the disclosure.

FIG. 4 shows an example clustering process according to some embodiments of the disclosure.

FIG. 5 shows an example classification process according to some embodiments of the disclosure.

FIGS. 6A-6K show example user interface elements according to some embodiments of the disclosure.

FIG. 7 shows an example onboarding process according to some embodiments of the disclosure.

FIG. 8 shows a computing device according to some embodiments of the disclosure.

### DETAILED DESCRIPTION OF SEVERAL EMBODIMENTS

Systems and methods described herein address the problems discussed above by gathering alarm data and automatically performing analyses, diagnostics, and metrics on generated alarms. Using machine learning (ML) and/or other techniques, the disclosed embodiments can identify high confidence (real) and high nuisance (noise) alarms based on factors such as alarm counts, repeat alarms, duration, nuisance alarms, occurrence and clearance time stamps, operator action or annunciations, etc. With dashboards and visualizations, disclosed embodiments can provide users with the information to identify the “offenders” and progressively rationalize and ultimately reduce noise and nuisance alarms. Embodiments can reduce alarms to manageable numbers, not missing critical or important alarms, and eliminate current practices of “mass acknowledgment.” In the disclosed systems and methods, the disclosed processing can be integrated into BMS user-focused tools and improve both backend and frontend operations of BMS or other systems. Embodiments can provide user interface (UI) elements that condense, focus, or otherwise indicate alarm severity and/or validity. Some embodiments may provide recommendations and may be configured to assist with intervention.

As described in detail below, the systems and methods described herein may address one or more of the following technical and/or user-focused problems: too many alarms, the risk of missing critical alarms and/or issues, system credibility, arbitrary alarm prioritization, inappropriate and/or false alarms, repeat and/or nuisance alarms, different BMS systems with sometimes radically different user interfaces and alarm handling mechanisms, ingesting and collating alarms from different sources (e.g., BMS and IoT), sorting real from noise, alarm histories/statistics/metrics for improvements and/or evidential issues, lack of site standardization, vague work orders, manual processes, specific skill set required to process alarms, and/or costly specialist support requirements.

In addressing the above problems, the disclosed systems and methods may provide one or more of the following outcome improvements: prioritized quantitative and qualitative actionable information, a common and unified UI without reliance on multiple BMS system UIs, accurate and easily accessible metrics, supplement work orders (WOs) with better information, automated WO generation, reduced risk of outages and disruption, ingesting/comparing/collating alarms and issues from multiple BMS systems as well as other systems, etc. Such outcome improvements may have real world impacts such as the following: optimized labor usage, improved first time fix rates, reduced skill set and training complexity, minimized reliance on specialist vendors, automated WOs, risk reduction, reduced outages and disruption by not missing genuine issues, effort reduction, reduced truck rolls, decreased costs and margin improvements, less reliance on skilled techs and operators (who with time may get to know real from false issues), improved client satisfaction and retention, reduced manual input requirements, etc.

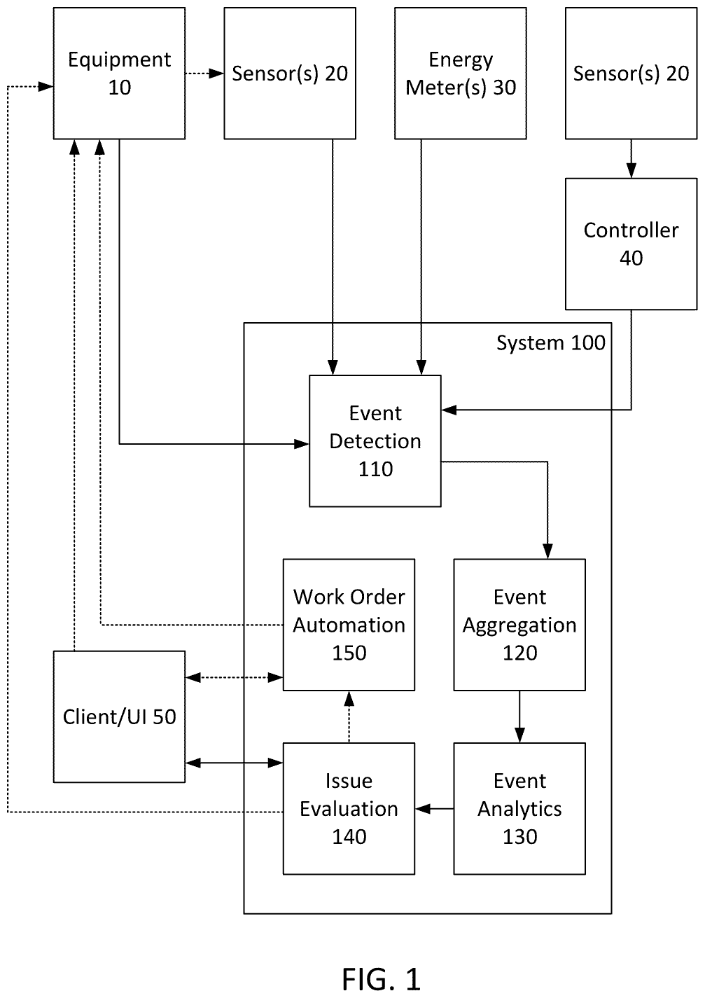

FIG. 1 shows an example alarm monitoring and evaluation system 100 according to some embodiments of the disclosure. System 100 may include a variety of hardware, firmware, and/or software components that interact with one another, such as event detection processing 110, event aggregation processing 120, event analytics processing 130, issue evaluation processing 140, and/or work order automation processing 150. The functions and operations of event detection processing 110, event aggregation processing 120, event analytics processing 130, issue evaluation processing 140, and work order automation processing 150 are described in greater detail below, but in general, one or more elements such as equipment 10 (e.g., an air handler unit (AHU) or other device), sensor(s) 20 (which may be stand alone or may be coupled to or in communication with equipment 10), energy meter(s) 30, and/or controller 40 (which may receive data from sensor(s) 20) can send data to event detection processing 110. Event detection processing 110 may detect events in certain types of communications (e.g., emails) and/or simply pass along messages that define an event with no detection processing required. event aggregation processing 120 can process data from event detection processing 110 to remove redundancies, for example in situations where multiple inputs report a same event or highly related events. Event analytics processing 130 can perform processing, such as machine learning (ML) processing, to determine confidence levels of alarms and/or events and, in some embodiments, generate scores for alarms and/or events. Based on the operation of event analytics processing 130, issue evaluation processing 140 can provide client/UI 50 with UI elements leveraging the determined confidence and/or score data and/or can provide data to work order automation processing 150. In turn, work order automation processing 150 can, for example, automatically generate work orders for events with high confidence levels or scores. As a result of processing by client/UI 50 and/or work order automation processing 150, true events can be dealt with, while nuisance alarms need not provoke any response. Thus, improvements to real-world operation of equipment 10 can be identified and implemented.

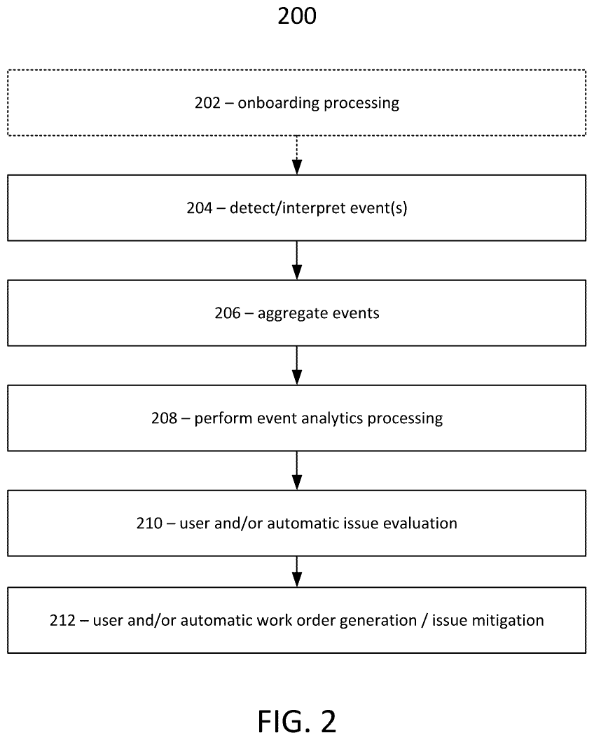

Some components may communicate with one another and/or with system 100 through one or more networks (e.g., the Internet, an intranet, and/or one or more networks that provide a cloud environment) and/or by local connections (e.g., within a building management system (BMS). Indeed, communication may involve one or more of a variety of known and/or novel protocols and/or technologies (e.g., BACnet, Modbus, Lon, Dali, KNX, ANSI, Zigbee, LoRa, 3G/4G/5G, etc.). FIGS. 2-6K provide details about the processing performed by system 100.

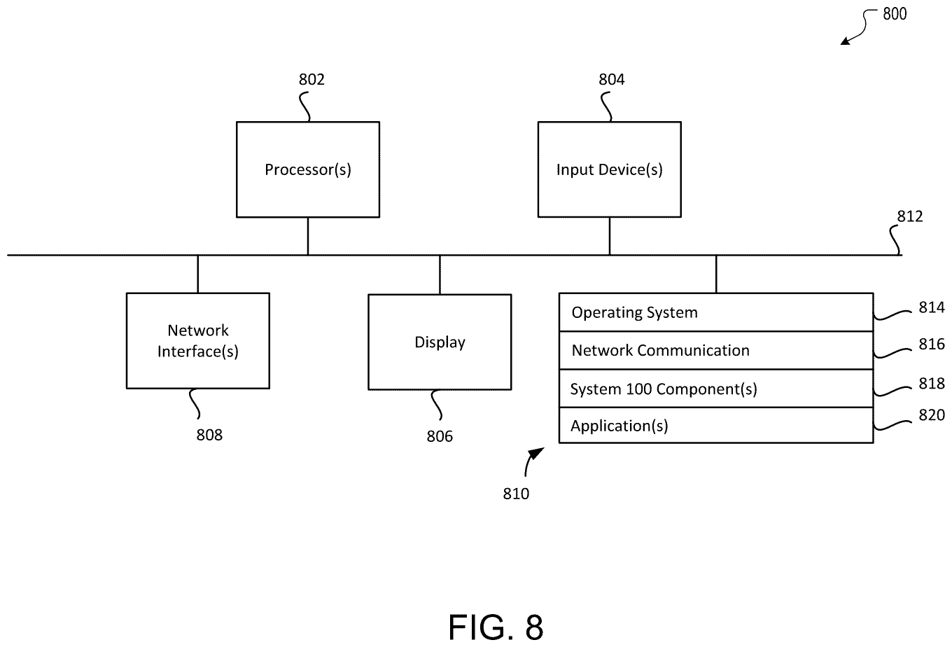

In some embodiments, system 100 components can be provided by separate computing devices communicating with one another through a network or some other connection(s). For example, event detection processing 110, event aggregation processing 120, event analytics processing 130, issue evaluation processing 140, and/or work order automation processing 150 may be respectively provided within different computing environments. In other embodiments, event detection processing 110, event aggregation processing 120, event analytics processing 130, issue evaluation processing 140, and/or work order automation processing 150 may be part of the same computing environment. Other combinations of computing environment configurations may be possible. Each component may be implemented by one or more computers (e.g., as described below with respect to FIG. 8).

Elements illustrated in FIG. 1 (e.g., system 100 (including event detection processing 110, event aggregation processing 120, event analytics processing 130, issue evaluation processing 140, and/or work order automation processing 150), equipment 10, sensor(s) 20, energy meter(s) 30, controller 40, and/or client/UI 50) are each depicted as single blocks for ease of illustration, but those of ordinary skill in the art will appreciate that these may be embodied in different forms for different implementations. For example, while event detection processing 110, event aggregation processing 120, event analytics processing 130, issue evaluation processing 140, and work order automation processing 150 are depicted separately, any combination of these elements may be part of a combined hardware, firmware, and/or software element. Likewise, while event detection processing 110, event aggregation processing 120, event analytics processing 130, issue evaluation processing 140, and work order automation processing 150 are each depicted as parts of a single system 100, any combination of these elements may be distributed among multiple logical and/or physical locations. Moreover, FIG. 1 shows respective single instances of event detection processing 110, event aggregation processing 120, event analytics processing 130, issue evaluation processing 140, and work order automation processing 150 for ease of explanation of certain operations. However, varying numbers of instances of event detection processing 110, event aggregation processing 120, event analytics processing 130, issue evaluation processing 140, and/or work order automation processing 150 may be possible in various embodiments. Also, while one equipment 10, two sensors 20, one energy meter 30, one controller 40, one client/UI 50, and one system 100 are illustrated, this is for clarity only, and multiples of any of the above elements may be present. In practice, there may be single instances or multiples of any of the illustrated elements, and/or these elements may be combined or co-located.

The example embodiments presented herein use an AHU as equipment 10, although this is only by way of example, and the systems and methods described herein are not limited to use with AHUs. A non-exhaustive set of device(s) and/or system(s) suitable to function as equipment 10 may include any building systems related to comfort, safety, productivity, security, compliance, control, monitoring, reporting, visualization, and/or alarms. For example, equipment 10 may include HVAC elements such as air conditioning units, other heating and/or cooling units, AHUs, fan coil units (FCUs), variable air volume (VAV) systems, boilers, chillers, variable speed drive (VSD) systems, fans, pumps, indoor air quality (IAQ) systems, occupancy control systems, etc. In further examples, equipment 10 may include BMSs, internet of things (IoT) devices, fire safety systems, security systems, power systems, lighting systems, computerized maintenance management systems (CMMS), computer-aided facility management (CAFM), etc.

FIG. 2 shows an example alarm monitoring and evaluation process 200 according to some embodiments of the disclosure. System 100 can perform process 200 to automatically gather alarm data, aggregate such data into events, prioritize such events, and enable event handling and/or mitigation, for example.

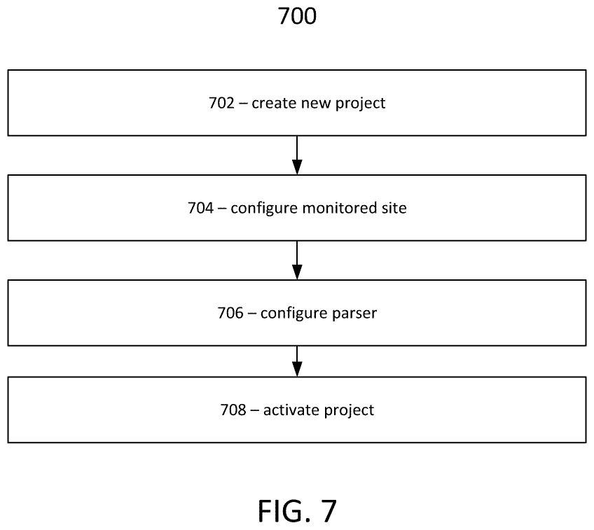

At 202, system 100 can perform onboarding processing. In at least some cases, such as when new equipment 10, sensor(s) 20, energy meter(s) 30, and/or controller(s) 40 are being added to a set of monitored elements, and/or when a new client/UI 50 is registering with system 100 to have its systems monitored by system 100, the new elements can be onboarded. By performing onboarding processing 202, system 100 can configure itself to use the new elements in process 200 to gather alarm data, process the alarm data, and enable event handling and/or mitigation. An example of onboarding processing is given below with reference to FIG. 7.

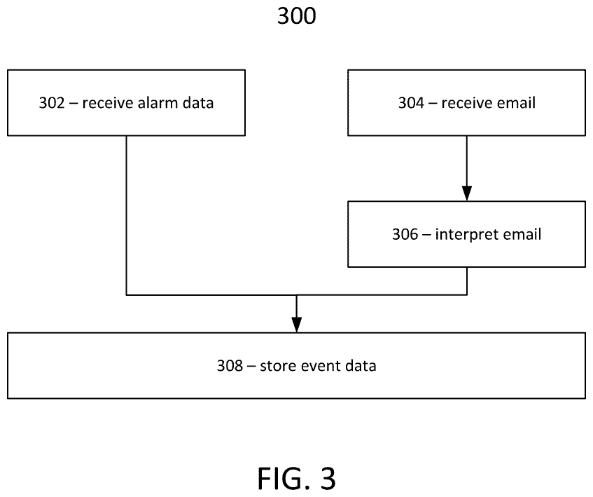

At 204, event detection processing 110 can detect one or more events from available data from sources such as equipment 10, sensor(s) 20, energy meter(s) 30, and/or controller 40. In some cases, a source can send information indicative of the event in a format used for reporting in a BMS context (e.g., a message that indicates an alarm state with no need for interpretation). In other cases, the information may be in the form of a human-readable communication such as an email message. In this case, event detection processing 110 can examine the email to recognize the event in the human-readable message. An example of event detection is given below with reference to FIG. 3.

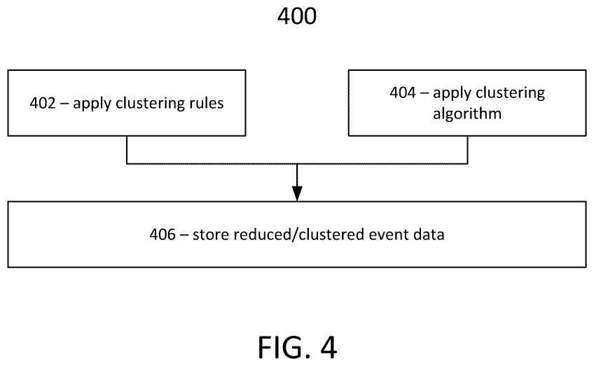

At 206, event aggregation processing 120 can aggregate events detected at 204. For example, event detection processing 110 can analyze the events detected at 204 to determine whether any of them refer to the same condition (e.g., multiple sensors reporting a temperature anomaly in an area serviced by an AHU and/or reporting a fault condition of the AHU). If so, event detection processing 110 can aggregate them into a single event. The single event may have encapsulated therein data from all sources reporting on the event to allow future processing to assess the validity of the event, in some embodiments. An example of event aggregation using a clustering technique is given below with reference to FIG. 4.

At 208, event analytics processing 130 can perform processing to determine the validity of events. This can include applying a ML model to incoming aggregated event data to determine whether it is likely to be valid and/or to assign a score indicative of its potential validity.

Event analytics processing 130 can utilize a variety of factors in determining whether an alarm is likely to be indicative of a real, valid event that should be fixed or at least examined. Ultimately, high confidence scores may be assigned to events that most likely have an immediate real-life impact, such as needing a work order for resolution. For example, a rare alarm for a critical piece of equipment 10 of a type having a wide impact on building occupancy may be given a higher score than a frequently recurring alarm for a redundant piece of equipment 10 that only affects a small area of a building.

For example, one factor may be the type of equipment 10. Issues with some equipment 10 may represent a major outage having, sometimes site wide, effects on productivity, health, occupancy, asset degradation, and/or cost. Chillers, boilers, some AHUs, and/or primary pumps are possible equipment 10 examples that may have high impact. Some types of equipment 10 issues may cause disruptions in more limited zones and/or may have less severe consequences such as floor comfort or energy policy compliance problems which may still be important but may be less so than the former category. Secondary pumps, some AHUs, FCUs, VAVs, and/or RTUs are possible equipment 10 examples that may have medium impact. Some types of equipment 10 issues may only cause inconvenience and/or annoyance (e.g., alarms generated by filters), and these may have low impact.

Another factor may be alarm count over time. A rare alarm having low historic counts may be more confidently assumed to be real than an alarm that recurs from time to time, which may in turn be more confidently assumed to be real than a frequent “noise” alarm (e.g., repeats frequently, high counts, known issue (such as in/out alarms), short duration, daily at a known time, etc.).

Another factor may be a selectable priority for a type of alarm. Selectable factors may include, for example, redundancy of equipment 10, ownership of equipment 10, and/or a severity level of a problem as indicated by the alarm itself.

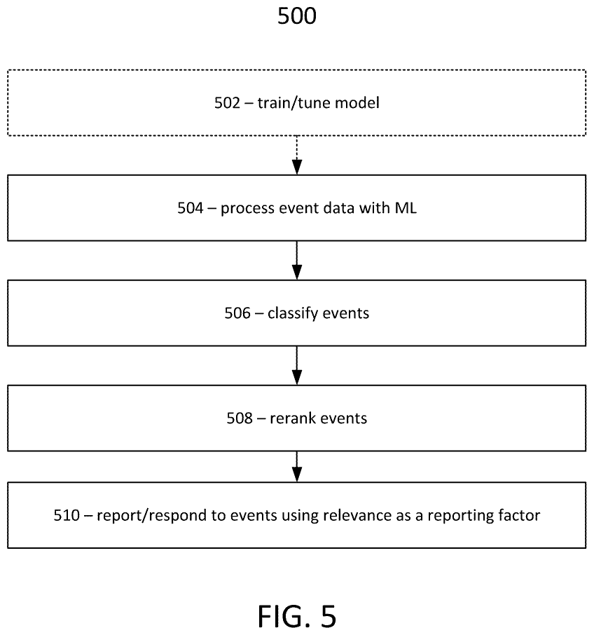

An example of event analytics processing involving ML classification of events is given below with reference to FIG. 5.

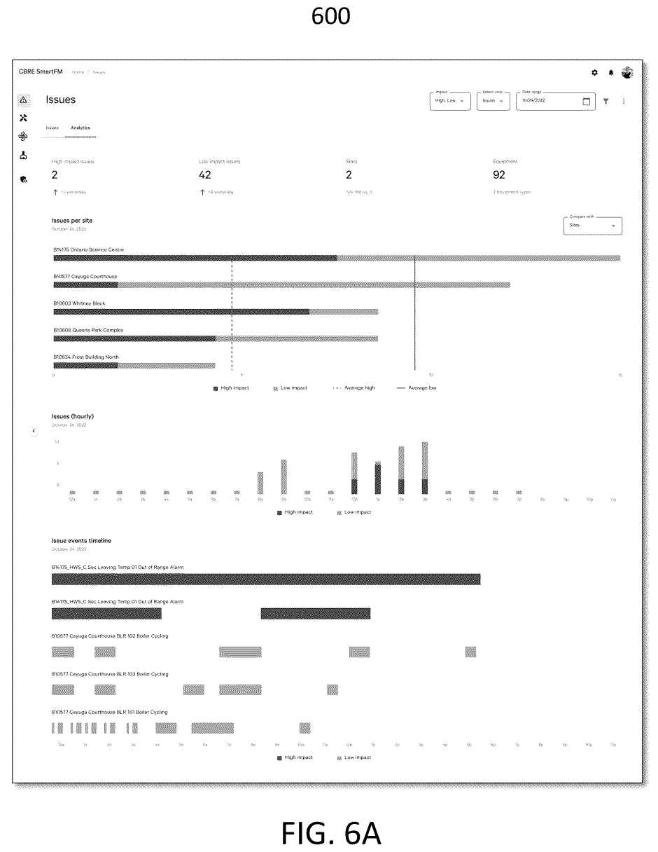

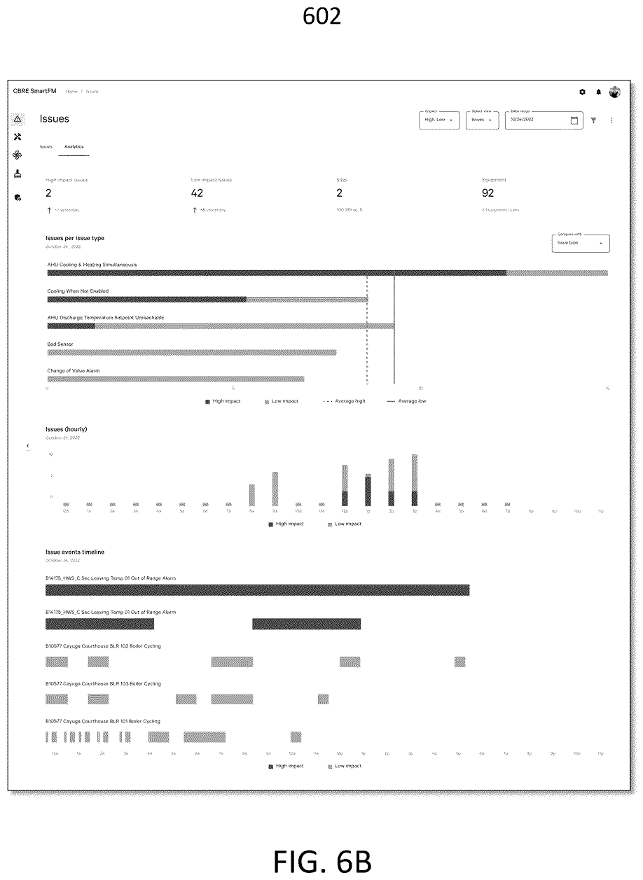

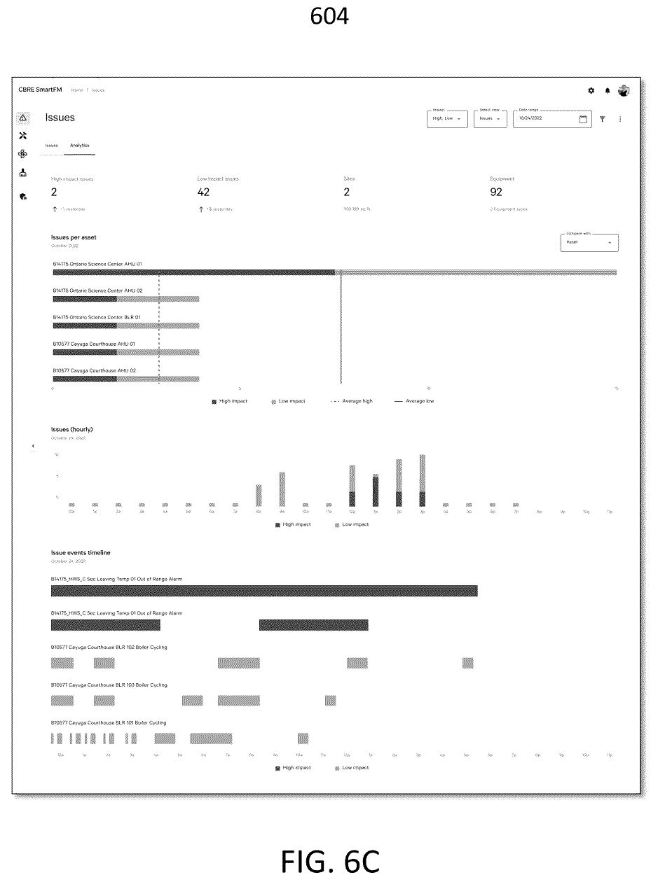

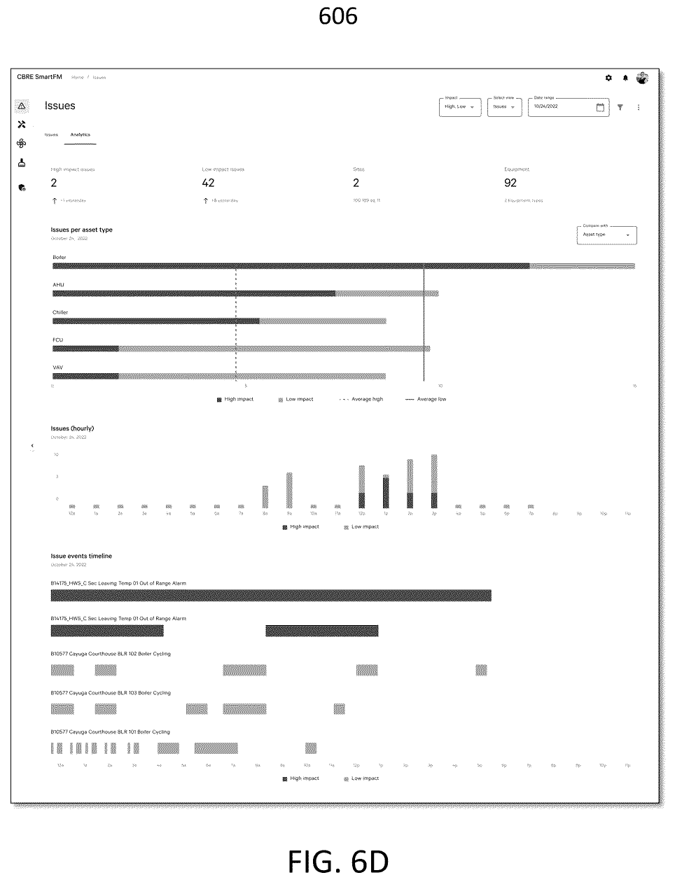

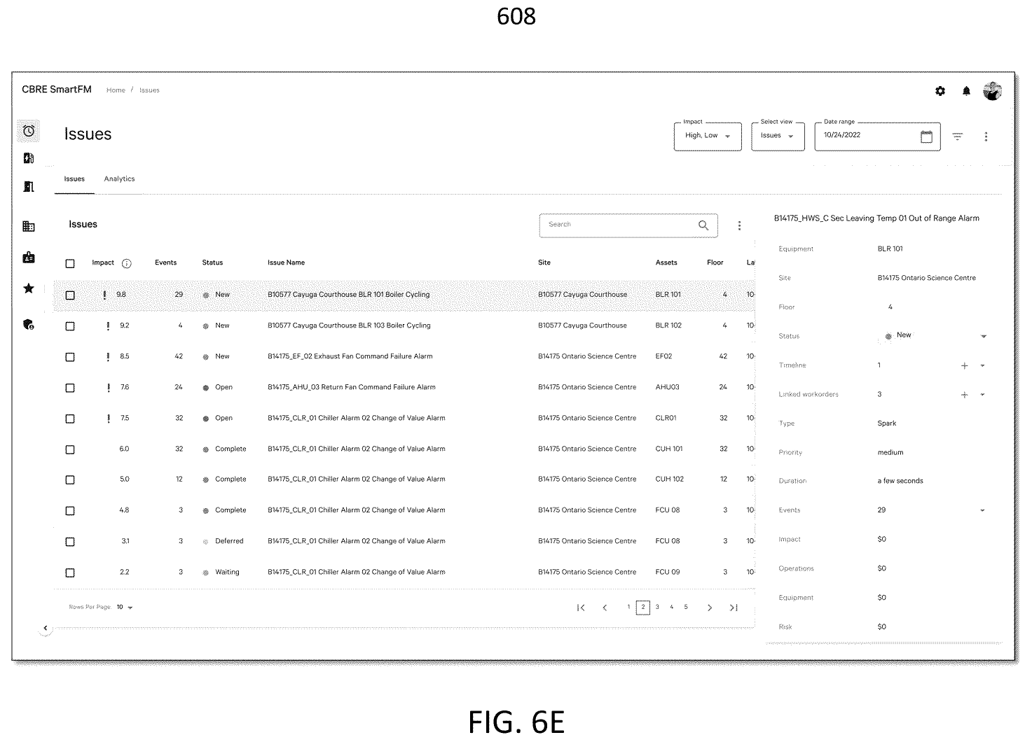

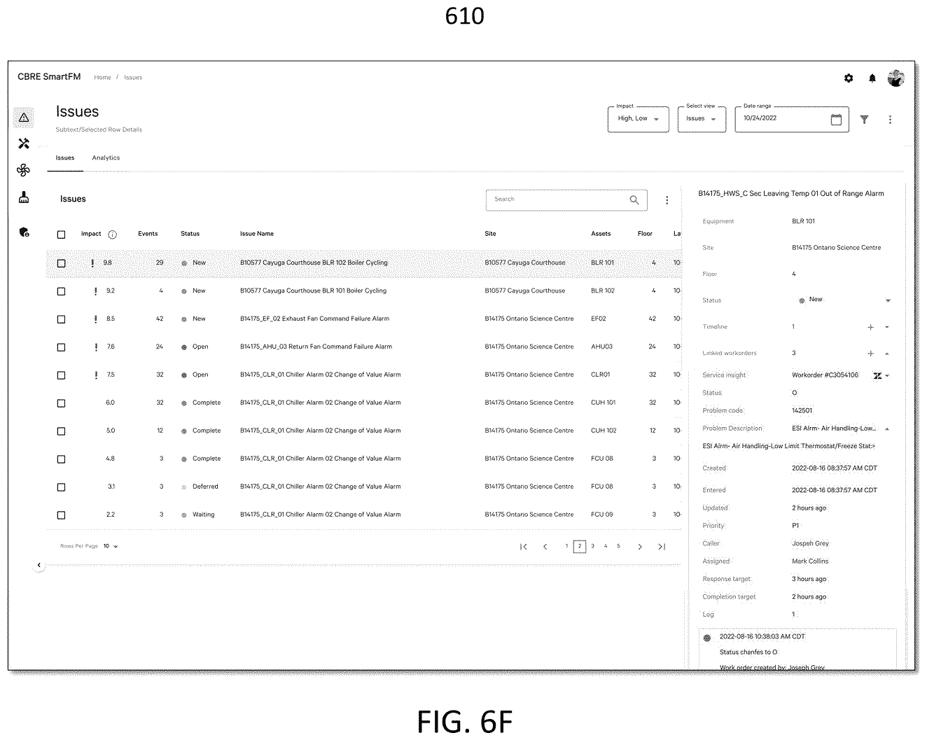

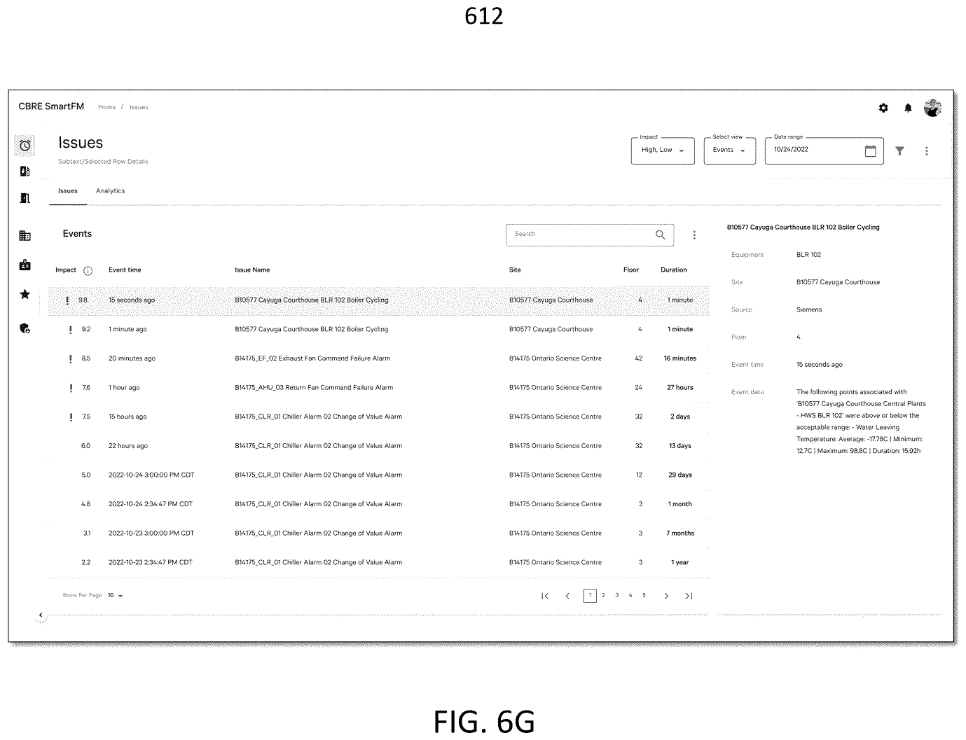

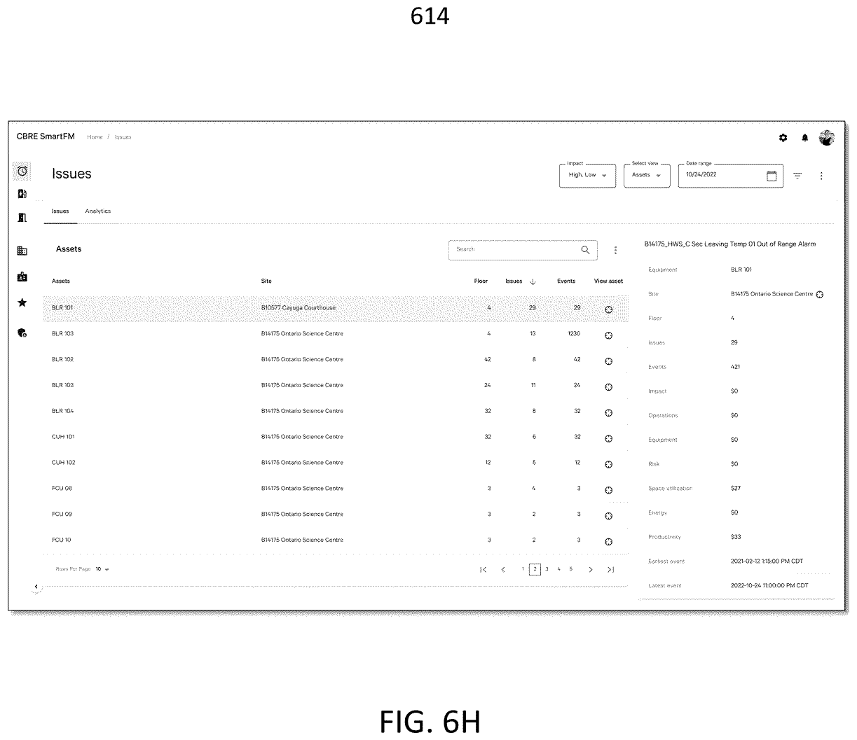

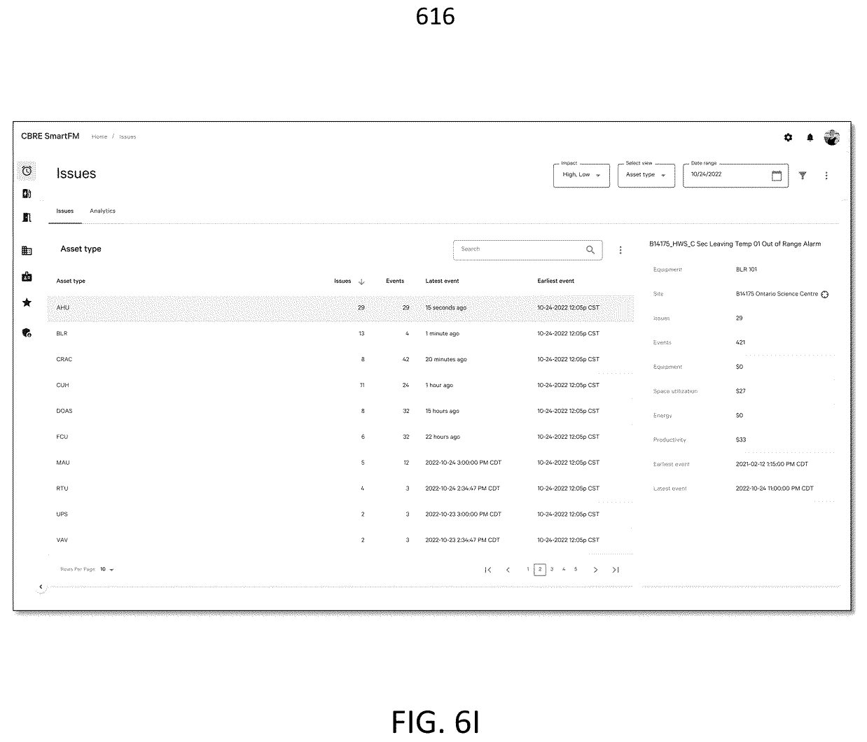

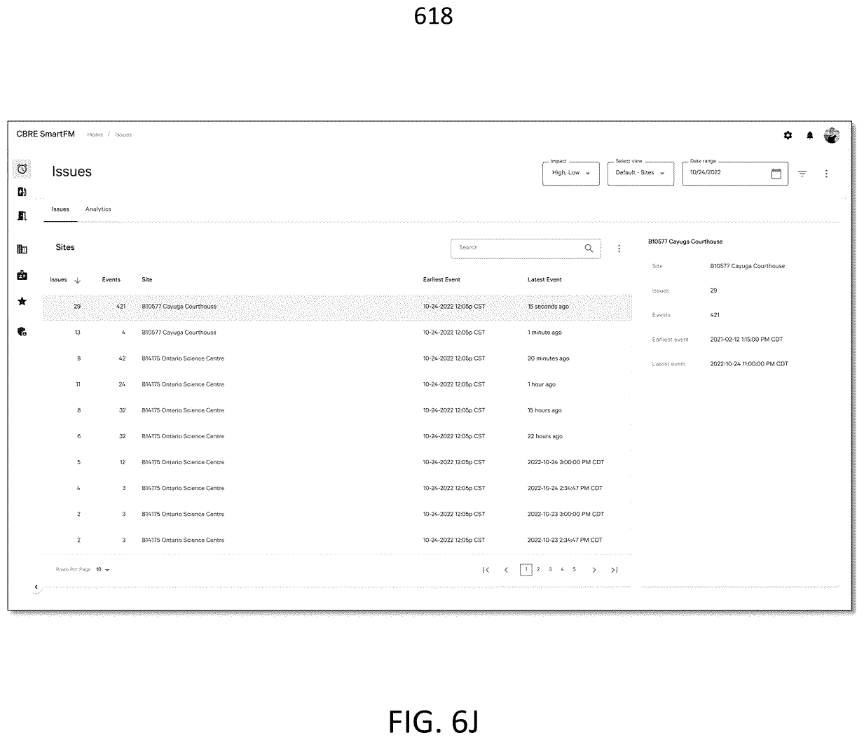

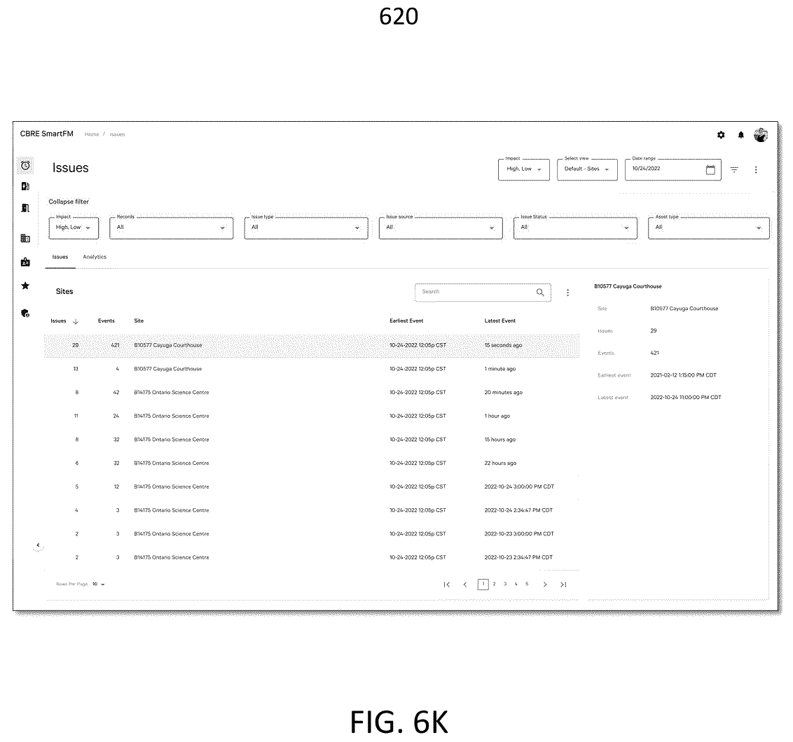

At 210, issue evaluation processing 140 can present information about events to a user through a UI of client/UI 50 and/or perform other actions based on processing at 208. For example, issue evaluation processing 140 can generate a UI showing prioritized alarms, ranked alarms, or otherwise highlighting likely valid alarms. Some UI examples, not intended to limit all embodiments, are described below with reference to FIGS. 6A-6K.

At 212, users can generate work orders for likely valid alarms using client/UI 50 and/or work order automation processing 150 can generate work orders for likely valid alarms. Generating work orders may include, for example, triggering an existing BMS work order automation system to send a work order and/or generating a message by system 100 itself. The message in the latter case may indicate the type of alarm and the equipment 10 to which it pertains, for example. System 100 can exclude events not scored above some threshold value or not otherwise indicated as likely valid from automatic work order processing, ensuring that work order automation processing 150 does not produce spurious work orders.

FIGS. 3-5 show subsets of process 200 in detail with illustrative, but not limiting, examples included to demonstrate how the disclosed embodiments can analyze alarms and thereby distinguish likely relevant from likely irrelevant alarms in a UI and/or for other purposes.

FIG. 3 shows an example event detection and interpretation process 300 according to some embodiments of the disclosure. System 100 can perform process 300 to gather alarm data relevant to equipment 10 operations and, if necessary, interpret or normalize the data. For example, system 100 can perform process 300 at 204 of process 200.

At 302, event detection processing 110 can receive alarm data in a machine-readable format reported by one or more of equipment 10, sensor(s) 20, energy meter(s) 30, and/or controller 40. The alarm data may include information that is relevant to subsequent processing described herein, such as alarm name, alarm site, alarm priority, alarm timestamp, and/or other data that may be determined to be relevant to determining an alarm's impact or importance. In some embodiments, the alarm data may include additional information. The information in the alarm data may be encoded for use in a BMS environment, for example, so that it may be in a state ready for consumption by a BMS UI system and may require no interpretation by event detection processing 110.

At 304, event detection processing 110 can receive information in a human-readable format, such as an email. This information may include alarm data, but the alarm data may not be in a format that is ready to use for a BMS.

At 306, event detection processing 110 can interpret the information received at 304 (e.g., in the email). Event detection processing 110 can identify and extract the relevant information (e.g., alarm name, alarm site, alarm priority, alarm timestamp, etc.). For example, one or more custom scripts may be deployed for clients and/or BMS integrators (Siemens, JCI, etc.). These scripts can target the various formats in which alarms and events are received and parse them out into fields like site name, source, value, state, timestamp, priority, time zone, etc.

At 308, event detection processing 110 can store the alarm data from 302 and/or the interpreted alarm data from 306 in a memory for subsequent processing. In some embodiments, event detection processing 110 may store only the aforementioned relevant subsets of the data (e.g., alarm name, alarm site, alarm priority, alarm timestamp, etc.).

FIG. 4 shows an example clustering process 400 according to some embodiments of the disclosure. System 100 can perform process 400 to cluster event data (e.g., as gathered by process 300 of FIG. 3). Clustering the alarm data can both reduce the data set to be processed in subsequent actions and surface additional data about event frequency. For example, system 100 can perform process 400 at 206 of process 200.

At 402, event aggregation processing 120 can cluster and/or aggregate event alarms based on one or more clustering rules. For example, rules may be related to alarm type (e.g., “high temperature alarm,” “low pressure alarm,” CO2 high alarm,” etc.). Thus, when an alarm is parsed, it may be aggregated along with other alarms of the same type (e.g., all “high temperature alarm” entries may be grouped together).

At 404, event aggregation processing 120 can apply one or more clustering algorithms to the event alarms to form clusters. Event aggregation processing 120 can apply the event alarms as inputs to ML clustering algorithms such as LSH, DBSCAN, K-means, and/or other known or novel algorithms. ML clustering algorithms may perform unsupervised learning processing to thereby group related alarms that are likely to have arisen from the same event or issue. Factors used to cluster events may include, but are not limited to, site, priority, time of day, day of week, seasonality, value (from sensor/equipment), state (acknowledged/unacknowledged), and/or frequency of events, for example.

Note that while process 400 shows both rules-based and ML clustering processing, some embodiments may use only rules-based processing, other embodiments may use only ML clustering processing, and other embodiments may use a combination of both approaches. In any case, after processing at 402 and/or 404, event aggregation processing 120 has developed a reduced set of events. At 406, event aggregation processing 120 can store data describing the reduced set of events for subsequent processing.

FIG. 5 shows an example classification process 500 according to some embodiments of the disclosure. System 100 can perform process 500 to identify high confidence and/or high nuisance alarms within event data (e.g., as clustered by clustering process 400). Process 500 provides alarm analytics, thereby enriching an alarm UI while streamlining it at the same time, and in some embodiments can automate work order generation. For example, system 100 can perform process 500 at 208-212 of process 200.

At 502, event analytics processing 130 may train and/or tune one or more ML models for event classification. One or more ML models may be used separately or in combination (e.g., as a stacked model combining two or more ML models). Such models may include, but are not limited to, logistic regression, random forest, XGBoost, LightGBM, catboost, neural network classifiers, BERT, and/or a black box such as Azure AutoML. For example, some embodiments may use a stacked model including three ML models (e.g., logistic regression as a base estimator, along with LightGBM and catboost).

To train an ML model or models, event analytics processing 130 may load a labeled training data set. The labeled training data set may include historical or simulated event data (e.g., as gathered by process 300 and prepared by clustering process 400 or by other processing). Each entry in the historical or simulated event data may be labeled with “high confidence,” “medium confidence,” or “low confidence,” respectively, in some embodiments. Other embodiments may use fewer (e.g., “high” and “low” only), more, or different labels. In any case, event analytics processing 130 may input the labeled training data set to the ML model(s) to be trained, and the ML model(s) may process the training data set according to their respective algorithms. In some embodiments, event analytics processing 130 may tune parameters of one or more ML model(s) according to design choice or other considerations. In some embodiments, at least one ML model may be an existing off-the-shelf model or unsupervised model that does not need to be trained, and in such cases the model may be tuned to function in process 500, if necessary.

As an example of tuning which may be used in some embodiments but that is not necessarily limiting of all embodiments, the features from event data that an ML model may take into account could include event count, issue site, issue created month, issue name, issue created time part of day, and issue priority. Tuning may assign a feature weight of 25 to event count, 20 to issue site, 20 to issue created month, 15 to issue name, 10 to issue created time part of day, and 5 to issue priority. Thus, in this example, a low event count may weigh heavily in favor of an alarm being genuine, even if issue priority for alarm type is low. Alternatively, a very high issue priority could potentially outweigh a high event count, but the weightings mean the priority would have to be significant. Other features may be used, and other weights may be given, in other embodiments.

In some cases, the ML model(s) will have been previously trained, but training and/or tuning may be part of process 500 when process 500 is performed a first time. Also, in some embodiments, training and/or tuning may be repeated at various times to ensure the ML model(s) is working in accordance with latest available training data.

At 504, event analytics processing 130 may process event data using the one or more ML models that have been trained and/or tuned as desired. Event data may include, for example, data as gathered by process 300 and prepared by clustering process 400. This event data can include, for each event, information such as, but not limited to, alarm name, alarm site, alarm priority, alarm timestamp, alarm count/frequency, etc. The event data may be processed by the one or more ML models. The one or more ML models may return a label for each event and a probability score for each label.

At 506, event analytics processing 130 may classify events that have been labeled by the ML processing at 504. At a basic level, this may include adopting the labels and probability scores generated by the ML processing at 504. In some embodiments, event analytics processing 130 may convert probability scores from a format used by the one or more ML models (e.g., 0-1 probability scale) to a different format (e.g., 0-100% scale). In some embodiments, probability scores may be multiplied by a number (e.g., 10) to produce an impact score that may be displayed in a UI in subsequent processing. In some embodiments, events having low confidence labels with probability scores above a threshold can be automatically labeled as nuisance alarms. In some embodiments, events having high confidence labels with probability scores above a threshold can be automatically labeled as genuine alarms.

At 508, event analytics processing 130 may rerank events. In some embodiments, known equipment 10 operational concerns may outweigh ML-driven classifications from 506. Accordingly, event analytics processing 130 can rerank events where such concerns apply. For example, in some embodiments, any events with records of work orders being issued in the event data may automatically be reranked as genuine alarms regardless of ML-generated label and probability score. In another example, equipment 10 may be considered sufficiently critical that all events should be investigated, such as in the case of life support equipment in a hospital setting. To perform the reranking, event analytics processing 130 may apply any known or novel “learning to rank” algorithm with parameters specified according to design considerations (e.g., specification of critical equipment 10). For example, event analytics processing 130 may apply Elastic Search, Solr, and/or LambdaMart algorithms to identify and rerank events.

At 510, event analytics processing 130 may report event analytics as developed at 504-508 and/or may automatically respond to some events, based on the determinations made at 504-508. For example, event analytics processing 130 may provide some or all results of processing at 504-508 to issue evaluation processing 140, which may package them into a UI displayed by client/UI 50. This can alter the operation of a typical alarm/event reporting UI by reducing the number of alarms surfaced as primary points of investigation for the user and also by introducing new UI elements to handle high priority alarms and, separately, to triage medium and/or low priority alarms in a different interface. Examples of such UI elements are presented in FIGS. 6A-6K as indicated below. Additionally or alternatively, in some embodiments, event analytics processing 130 may provide some or all results of processing at 504-508 to work order automation processing 150, which may automatically generate work orders for events having high confidence labels with probability scores above a threshold. The work orders can be sent to users (e.g., through client/UI 50) for fulfilment.

FIGS. 6A-6K show example UI elements according to some embodiments of the disclosure. Issue evaluation processing 140 and/or client/UI 50 can generate these and/or other UI elements based on the processing described above with respect to FIGS. 2-5.

FIG. 6A shows a wireframe of an example issues per site alarm analytics UI 600, FIG. 6B shows a wireframe of an example issues per type alarm analytics UI 602, FIG. 6C shows a wireframe of an example issues per asset alarm analytics UI 604, and FIG. 6D shows a wireframe of an example issues per asset type alarm analytics UI 606. In each UI, issues may be presented as high impact or low impact depending on how they were scored in process 500.

FIG. 6E shows a wireframe of an example home screen with impact analysis UI 608, FIG. 6F shows a wireframe of an example CMMS integration UI 610, and FIG. 6G shows a wireframe of an example events view UI 612. In each UI, a column showing the impact score, allowing users to rank events by impact score, is included. Users may be able to click on linked work orders to show additional details, which may include the priority level (e.g., “high,” “medium,” or “low”).

FIGS. 6H-6K show additional features of the events view UI, including laddering up issues to their respective assets to illustrate multiple different issues within a single asset 614, asset rollup 616, site rollup 618, and filtering 620. As shown, UI features may provide the ability to filter according to priority level.

FIG. 7 shows an example onboarding process 700 according to some embodiments of the disclosure. System 100 can perform onboarding process 700 to set up alarm monitoring and evaluation, for example at 202 of process 200 as described above. System 100 can perform onboarding process, or portions thereof, when a new client/UI 50 and/or monitored system (which may include equipment 10, sensor(s) 20, energy meter(s) 30, and/or controller(s) 40) is being initially configured and/or when an existing client/UI 50 and/or monitored system is being modified (e.g., through addition and/or removal of equipment 10, sensor(s) 20, energy meter(s) 30, and/or controller(s) 40).

At 702, system 100 can create a new project in cases where a new client/UI 50 and/or monitored system is being onboarded. Creating a new project can include provisioning UI elements such as project name and project type (e.g., enterprise, IoT, local, etc.).

At 704, system 100 can configure a site to be monitored. For example, system 100 can receive a navigation file, which may include information related to buildings, assets, and/or site location (state, city, country, etc.). For example, such information can include, but is not limited to, entity (e.g., building, asset, site, or subset of any of these) name, respective pointers or identifiers for any systems (e.g., equipment 10, sensor(s) 20, energy meter(s) 30, and/or controller(s) 40) that are already configured to send and/or are actively sending data to a BMS system such as SkySpark or similar, node type (e.g., building, floor, equipment, etc.), metadata, enablement flag(s), equipment type, path defining parents of a given node (e.g., building and floor for a particular piece of equipment 10), and/or other data. System 100 can receive this data and, in some embodiments, check for errors. In some embodiments, system 100 can also collect historical data for the site elements, which can be used for training as described in detail above (e.g., at 502 of process 500). Configuration at 704 can enable system 100 to collect machine-readable data not requiring parsing as described above.

At 706, system 100 can configure one or more parsers if required for any elements reporting in human-readable format. For example, system 100 can provide a UI enabling an administrator to label past emails as coming from specific sources and/or as reporting specific issues. Once system 100 has received this data, system 100 can use the labeled keywords to identify and classify human-readable messages as described above. In some embodiments, system 100 can perform testing at this stage, whereby system 100 can attempt to classify incoming and/or sample emails and present results in the admin UI for confirmation or correction. In some embodiments, labeling can be performed automatically by a large language model or similar system. In some embodiments, processing at 706 may be repeated periodically to ensure that system 100 is able to continue processing human-readable messages in case of changes in message format or keywords or the like. In any event, once system 100 has received labels it may be able to process human-readable messages.

At 708, system 100 can activate the new project. For example, an admin user may be able to activate and/or deactivate projects using a UI. Once a project is activated, system 100 can perform any of the processing described above for the project.

FIG. 8 shows a computing device 800 according to some embodiments of the disclosure. For example, computing device 800 may function as a single system 100 or any portion(s) thereof, or multiple computing devices 800 may function as a system 100.

Computing device 800 may be implemented on any electronic device that runs software applications derived from compiled instructions, including without limitation personal computers, servers, smart phones, media players, electronic tablets, game consoles, email devices, etc. In some implementations, computing device 800 may include one or more processors 802, one or more input devices 804, one or more display devices 806, one or more network interfaces 808, and one or more computer-readable mediums 810. Each of these components may be coupled by bus 812, and in some embodiments, these components may be distributed among multiple physical locations and coupled by a network.

Display device 806 may be any known display technology, including but not limited to display devices using Liquid Crystal Display (LCD) or Light Emitting Diode (LED) technology. Processor(s) 802 may use any known processor technology, including but not limited to graphics processors and multi-core processors. Input device 804 may be any known input device technology, including but not limited to a keyboard (including a virtual keyboard), mouse, track ball, and touch-sensitive pad or display. Bus 812 may be any known internal or external bus technology, including but not limited to ISA, EISA, PCI, PCI Express, NuBus, USB, Serial ATA or FireWire. In some embodiments, some or all devices shown as coupled by bus 812 may not be coupled to one another by a physical bus, but by a network connection, for example. Computer-readable medium 810 may be any medium that participates in providing instructions to processor(s) 802 for execution, including without limitation, non-volatile storage media (e.g., optical disks, magnetic disks, flash drives, etc.), or volatile media (e.g., SDRAM, ROM, etc.).

Computer-readable medium 810 may include various instructions 814 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 804; sending output to display device 806; keeping track of files and directories on computer-readable medium 810; controlling peripheral devices (e.g., disk drives, printers, etc.) which can be controlled directly or through an I/O controller; and managing traffic on bus 812. Network communications instructions 816 may establish and maintain network connections (e.g., software for implementing communication protocols, such as TCP/IP, HTTP, Ethernet, telephony, etc.).

System 100 components 818 may include the system elements and/or the instructions that enable computing device 800 to perform functions of system 100 as described above. Application(s) 820 may be an application that uses or implements the outcome of processes described herein and/or other processes. In some embodiments, the various processes may also be implemented in operating system 814.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A method comprising:
receiving, by at least one processor, event data describing a plurality of events related to equipment managed by a building management system (BMS);
processing, by the at least one processor, the event data using at least one machine learning (ML) model, wherein outputs of the at least one ML model include at least a priority label and a probability score for each respective event in the event data;
generating, by the at least one processor, a user interface within the BMS, the user interface indicating at least the priority label and the probability score for at least one of the events; and
causing, by the at least one processor, display of the user interface.

2. The method of claim 1, further comprising clustering, by the at least one processor, the event data to correlate indications of at least one specific event prior to the processing and produce at least an alarm count for the at least one specific event.

3. The method of claim 2, wherein the clustering comprises at least one of applying a clustering rule and processing the event data using a ML clustering algorithm.

4. The method of claim 1, wherein the event data includes at least one of alarm name, alarm site, alarm priority, alarm timestamp, alarm count, and alarm frequency.

5. The method of claim 1, further comprising reranking, by the at least one processor, at least one of the events prior to the generating.

6. The method of claim 5, wherein the reranking comprises overriding a priority label for at least one of an event with an existing work order and an event for equipment having a critical status.

7. The method of claim 1, further comprising generating, by the at least one processor, a work order within the BMS in response to a priority label having a high status and a probability score being above a threshold value for at least one of the events.

8. The method of claim 1, wherein the user interface displays data for events having a high status and a probability score above a threshold value while suppressing display of data for events having a low status.

9. The method of claim 1, further comprising tuning, by the at least one processor, the at least one ML model to weight respective categories of event data.

10. The method of claim 1, further comprising training, by the at least one processor, the at least one ML model using labeled historical and/or simulated event data.

11. A system comprising:
at least one processor; and
at least one non-transitory computer readable medium storing instructions that, when executed by the at least one processor, cause the at least one processor to perform processing comprising:
processing event data describing a plurality of events related to equipment managed by a building management system (BMS) using at least one machine learning (ML) model, wherein outputs of the at least one ML model include at least a priority label and a probability score for each respective event in the event data;
generating a user interface within the BMS, the user interface indicating at least the priority label and the probability score for at least one of the events; and
causing display of the user interface.

12. The system of claim 11, wherein the processing further comprises clustering the event data to correlate indications of at least one specific event prior to the processing and produce at least an alarm count for the at least one specific event.

13. The system of claim 12, wherein the clustering comprises at least one of applying a clustering rule and processing the event data using a ML clustering algorithm.

14. The system of claim 11, wherein the event data includes at least one of alarm name, alarm site, alarm priority, alarm timestamp, alarm count, and alarm frequency.

15. The system of claim 11, wherein the processing further comprises reranking at least one of the events prior to the generating.

16. The system of claim 15, wherein the reranking comprises overriding a priority label for at least one of an event with an existing work order and an event for equipment having a critical status.

17. The system of claim 11, wherein the processing further comprises generating a work order within the BMS in response to a priority label having a high status and a probability score being above a threshold value for at least one of the events.

18. The system of claim 11, wherein the user interface displays data for events having a high status and a probability score above a threshold value while suppressing display of data for events having a low status.

19. The system of claim 11, wherein the processing further comprises tuning the at least one ML model to weight respective categories of event data.

20. The system of claim 11, wherein the processing further comprises training the at least one ML model using labeled historical and/or simulated event data.
